(19) United States
(12) Patent Application Publication
(10) Pub. No.: US 2008/0081629 A1
(43) Pub. Date: Apr. 3, 2008

(54) Control of schedulation

(75) Inventors: Antti Piipponen, Tampere (FI); Tommi Zetterman, Helsinki (FI); Kalle Raiskila, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/634,990

(22) Filed: Dec. 7, 2006

(30) Foreign Application Priority Data
Oct. 2, 2006 (FI) 20065620

(51) Int. Cl. H04Q 7/20

(52) U.S. Cl. 455/450

(57) ABSTRACT

The invention relates to a mobile terminal, for instance. The terminal includes a processing unit for receiving operations relating to at least two communication processes of different radio communication systems, wherein each communication process includes a critical operation and one or more pre-requisite operations, and wherein a scheduling window defining a time window within which an operation is to be scheduled is defined for each operation. There is provided a shared medium for handling operations relating to the communication processes and a scheduler for scheduling the operations to the shared medium, the scheduler scheduling the operations such that the pre-requisite operations precede the critical operation of that communication process, and each pre-requisite operation is scheduled to its scheduling window.

### FIELD

The invention relates to an apparatus, a method, a computer program and a computer program distribution medium.

### BACKGROUND

New radio technologies are emerging, and user devices in a communications system are designed to be capable of using multiple radio systems, such as Global System for Mobile communication (GSM), Universal Mobile Telephone System (UMTS) and Personal Communications Services (PCS).

Additionally, new kind of services and networks other than cellular radio systems have also been developed. Examples of such services are Wireless Local Area Network (WLAN) offering a wireless access to the Internet, Global Positioning System (GPS) and Digital Video Broadcasting—Handheld (DVB-H) offering reception of digital television transmissions.

If a communication device supports more than one communications system, such as UMTS, or service protocol, such as DVB-H, the device can be called a multiradio device.

Multiradio devices supporting multiple communication systems have traditionally system-specific transmitter/receiver chains, which is not optimal in view of usage of resources in the multiradio device.

### SUMMARY

In one aspect, there is provided an apparatus, comprising a processing unit configured to receive a plurality of operations relating to at least two communication processes of different radio communication systems, wherein each communication process includes a critical operation and one or more pre-requisite operations, and wherein a scheduling window defining a time window within which an operation is to be scheduled, is defined for each operation, a shared medium for handling operations relating to the at least two communication processes, a scheduler for scheduling the operations to the shared medium, the scheduler being configured to schedule the operations such that the pre-requisite operations of a communication process precede the critical operation of that communication process, and each pre-requisite operation is scheduled to its scheduling window.

In another aspect, there is provided an apparatus, comprising means for receiving a plurality of operations relating to at least two communicaiton processes of different radio communication systems, wherein each communication process includes a critical operation and one or more pre-requisite operations, and wherein a scheduling window defining a time window within which an operation is to be scheduled is defined for each operation, means for handling operations relating to the at least two communication processes, means for scheduling the operations to the shared medium, the scheduler being configured to schedule the operations such that the pre-requisite operations of a communication process precede the critical operation of that communication process, and each pre-requisite operation is scheduled to its scheduling window.

In another aspect, there is provided a method, comprising: receiving a plurality of operations relating to at least two communication processes of different radio communication systems, wherein each communication process includes a critical operation and one or more pre-requisite operations, and wherein a scheduling window defining a time window within which an operation is to be scheduled, is defined for each operation, a scheduler for scheduling the operations relating to the at least two communication processes to a medium shared by the at least two communication processes such that the pre-requisite operations of a communication process precede the critical operation of that communication process, and each pre-requisite operation is scheduled to its scheduling window.

In another aspect, there is provided a computer program product encoding a computer program of instructions for executing a computer process for implementing the method.

In another aspect, there is provided computer program distribution medium readable by a computer and encoding a computer program of instructions for executing a computer process for implementing the method.

### DRAWINGS

In the following, the invention will be described in greater detail with reference to the embodiments and the accompanying drawings, in which

FIG. 1 shows a mobile communication network;

FIG. 2 shows an embodiment of a method;

FIG. 3 shows an embodiment of scheduling;

FIG. 4 shows another embodiment of scheduling;

FIG. 5 shows another embodiment of scheduling;

FIG. 6 shows another embodiment of scheduling;

FIG. 7 shows another embodiment of scheduling, and

FIG. 8 shows an embodiment of an apparatus.

### EMBODIMENTS

There are many different radio protocols that are used in communications systems. Some examples of different communication systems are the Universal Mobile Telecommunications System (UMTS) radio access network (UTRAN), Global System for Mobile Communications (GSM) and its modifications, Wireless Local Area Network (WLAN), Worldwide Interoperability for Microwave Access (WiMAX), Bluetooth, Personal Communications Services (PCS) and systems using ultra-wideband (UWB) technology.

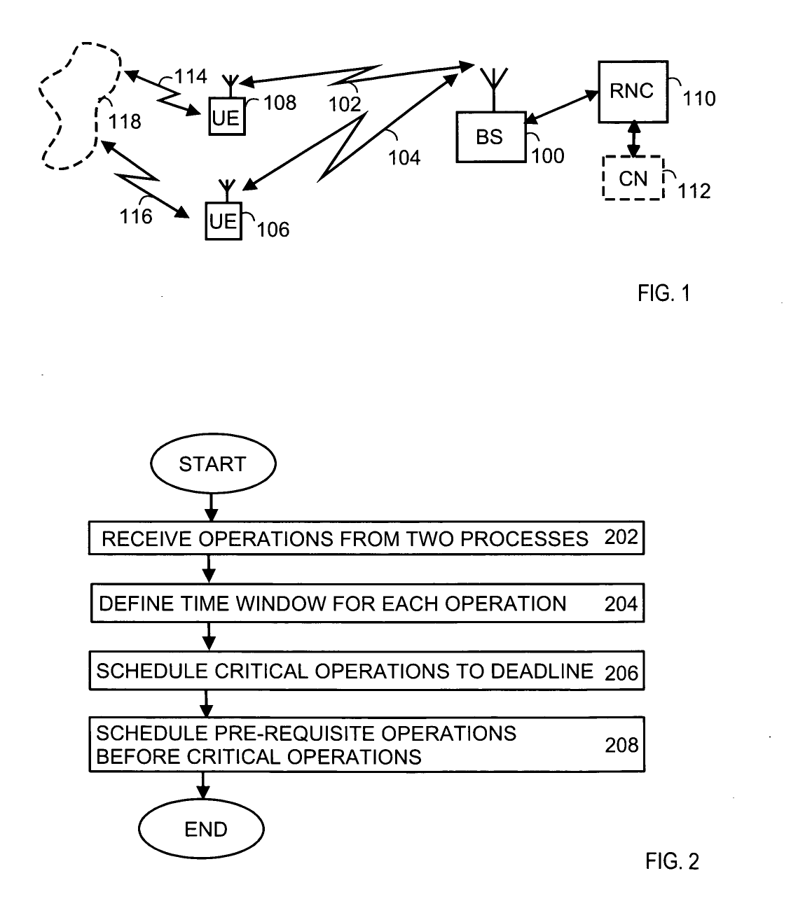

FIG. 1 is a simplified illustration of a communications system to which embodiments according to the invention are applicable. FIG. 1 shows a part of a UMTS radio access network (UTRAN). UTRAN is a radio access network, which includes wideband code division multiple access (WCDMA) technology.

The communications system of FIG. 1 is a cellular radio system, which comprises a base station (or node B) 100, which has bi-directional radio links 102 and 104 to user devices 106 and 108. The user devices may be fixed, vehicle-mounted or portable. The user devices may be multiradio devices being equipped to operate in a plurality of communication systems and/or providing support for several services. Hence, in this example, the user devices are able to support in addition to UMTS also WLAN or Bluetooth, for instance. The other systems are marked in FIG. 1 with a cloud 118 and connections to other communications systems are marked in FIG. 1 with arrows 114, 116.

The base station includes transceivers, for instance. From the transceivers of the base station, a connection is provided to an antenna unit that establishes bidirectional radio links to the user devices. The base station is further connected to a controller 110, such as a radio network controller (RNC), which further transmits the connections of the devices to the other parts of the network. The radio network controller controls in a centralized manner several base stations connected to it. The radio network controller is further connected to a core network 112 (CN). Depending on the system, the counterpart on the CN side may be a mobile services switching centre (MSC), a media gateway (MGW) or a serving GPRS (general packet radio service) support node (SGSN), for instance. It should be noticed that in future radio networks, the functionality of an RNC may be distributed among (possibly a subset on base stations.

The embodiments are not, however, restricted to the system given as an example but a person skilled in the art may apply the solution to other communication systems provided with the necessary properties. Different multiple radio protocols may be used in the communications systems in which embodiments of the invention are applicable. The communication system may also be able to communicate with other networks, such as a public switched telephone network or the Internet.

Next, an embodiment of a method is explained with reference to FIG. 2. The method relates to a multiradio device, such as a radio transceiver, which is capable of operating with at least two different radio systems.

In 202, a multiradio device processes hardware access requests from two simultaneously active radio protocols operated by the device. In the multiradio device, the receiver and transmitter chains are usually reconfigureable such that they may be used by different communications systems. In other words, there are no separate transceivers for each supported system but the systems may share common hardware resources, which may be accessed roughly at the same time by the different systems. There may be multiple receiver and transmitter chains if the protocols cannot be efficiently time multiplexed on one transceiver chain.

As an example of the importance of controlling shared resources, we may consider a TDMA (Time Division Multiple Access) system, where communicating radio devices rely on correct timing of transmissions, that is start and stop of transmit bursts. Even though the exact timing is usually a function of baseband processing, the radio frequency (RF) hardware must be controlled with a sufficient timing accuracy to ensure correct operation. For example, if the transmitter power amplifier is activated too early, the RF carrier is output to the air, thereby violating the radio standard. Similarly, if the activation of the hardware comes too late, the start of the transmit burst will not likely be recognized at the receiver due to missing or corrupted synchronization info.

Coordinating of the shared resources is also important in view of power consumption of the radio devices. Keeping the RF signal chain powered up consumes power and thus components should not be activated for too long. As one option, RF signal processing blocks may have small, distributed voltage regulators. Alternatively, a centralized control may be provided.

The resource requests made by the different radio systems may be divided into critical and pre-requisite operations, which pre-requisite operations happen before the critical operations. For example, if the main operation is the start of transmission burst, the critical deadline is determined by the radio protocol, and the power amplifier must be activated at that given moment. Thus the critical operation in this example is the activation of the power amplifier, which has to occur exactly at a specified moment. There are a number of tasks, pre-requisite operations, which have to be carried out before executing the critical operation. The pre-requisite operations might include powering up power to transmitter blocks, setting up a frequency synthesizer to output a carrier frequency and configuring the transmitter chain with the right output power.

In 204, a time window is determined for each operation. The time window defines an earliest activation time and a latest activation time for the operation. The operation may include writing a configuration, such as power gain of a hardware component, for instance, to a hardware register or provision of an enable/disable signal, thereby activating/de-activating the hardware component. In the case of critical operations, the earliest activation time and the latest activation time are the same, because the operation is to be executed exactly at a given time, defined by the radio protocol, for instance. The time windows of the pre-requisite operations may be longer. The only definite constraint is that the pre-requisite operations must have been executed before the critical operation.

In 206, the critical operations are scheduled to the dead-line. The latest allowed activation moment is the same as the earliest allowed activation moment for the critical operations. Scheduling may here include placing operations in a bus, which is shared by the communication processes operated by the device. Subsequently, the bus delivers and writes the operations to hardware registers such that the hardware is activated at the proper moment of time.

In 208, the pre-requisite operations of the at least two communication systems are scheduled. In one embodiment, the number of operations, such as hardware write requests, is calculated and a corresponding total time is reserved from a shared medium when the time needed for conveying one hardware write request is known. Then, the write requests may be written immediately following each other and there are no time gaps between the write operations in the bus.

In an embodiment, the pre-requisite operations have to be scheduled at least partly in a specified order. Some pre-requisite operation may be a pre-requisite operation for another pre-requisite operation, which has to be taken into account in the scheduling.

Additionally, the bus delay and hardware settling or activation time may need to be taken into account both with respect to the critical and pre-requisite operations. Such delay values may be taken into account by scheduling an operation early enough such that the activation of the hardware component is within the time window even though one or more additional delay components affect the execution of the write operation.

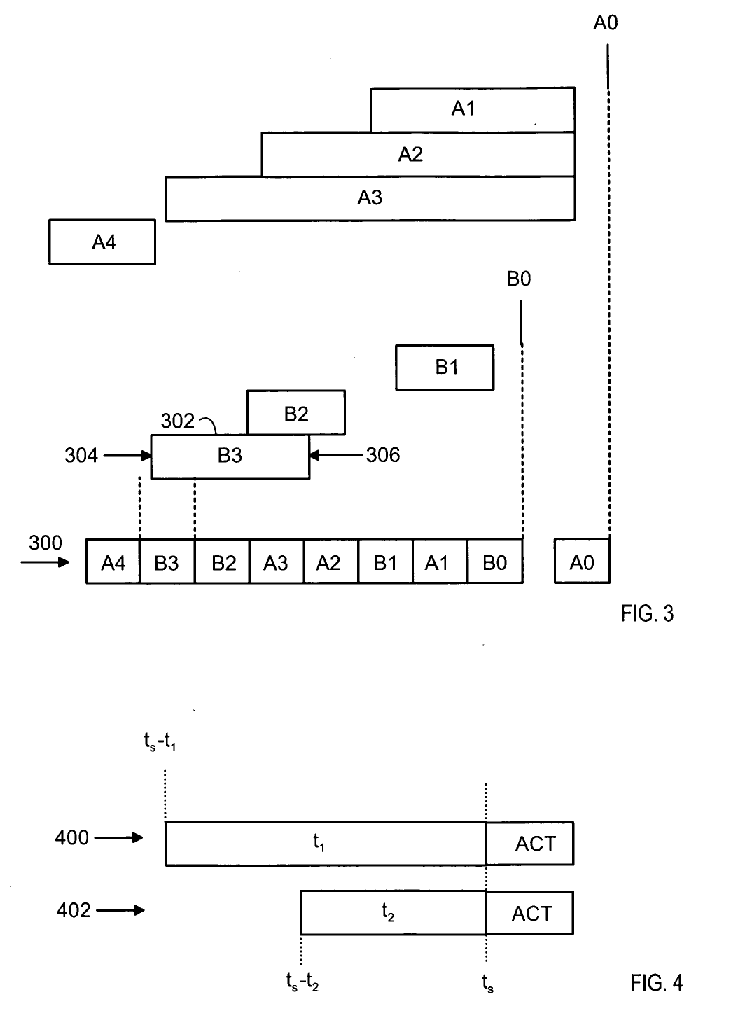

FIG. 3 shows an example of the scheduling of operations relating to two communication processes A and B. The operations of the first communication process are illustrated by blocks A0 to A4 and the operations of the second communication process by blocks B0 to B3. A data bus shared by the communication processes A and B is depicted by reference 300.

The critical operations of the communication processes A and B have been depicted by A0 and B0, respectively. The scheduling of the write operations of the critical operations are shown by dashed lines and as FIG. 3 shows, the operations are scheduled to the bus 300 exactly at the moment they are to be executed.

Process A includes four pre-requisite processes A1 to A4, which must be performed before the critical operation A0. In the embodiment of FIG. 3 we may assume that A4 is a pre-requisite operation to the other pre-requisite operations A1, A2 and A3. This can be seen from that the activation window of A4 is placed before, in time, the activation windows of the other pre-requisite operations. As FIG. 3 shows, the activation windows of A1, A2 and A3 are partly overlapping. From the overlapping activation windows alone, it cannot be deduced that the operations would not have any sequential dependency with respect to each other. One factor affecting the length of the activation window is a settling time of a hardware component.

If we assume that A4 is a pre-requisite operation to the other pre-requisite operations A1, A2 and A3, it has to be noted that if the activation window A4 is moved to an earlier/later moment of time, this also may have effect on the other activation windows. For instance, is A4 is moved later, the activation windows of the other pre-requisite operations may have to be moved, or their length may have to be adjusted (shortened).

The communication process B includes three pre-requisite processes Bi to B3. Each pre-requisite process has a time window, of which the time window of operation B3 is shown by reference 302. The time window 302 defines an earliest allowed moment of time 304, and a latest allowed moment of time 306. It has to be noted that the window 302 defines the time window within which the component shall be activated. As the leftmost dashed line originating from block B3 in the bus 300 shows, the start of the write command is earlier than the earliest allowed activation time 304 of operation B3. However, the end of a timeslot reserved for command B3 in the bus 300 defines the actual activation moment of the hardware component and this is within the window 302.

Although not necessarily the case, B2 and B3 may be pre-requisite operations to the pre-requisite operation B1, because the activation windows of B2 and B3 finish before start of the activation window of B1. Alternatively, it may be assumed that B1 is scheduled late due to its great power consumption.

FIG. 3 shows that there is a time gap between the write operations of the critical operations in the bus 300. However, there are no time gaps between the write operations starting from A4 and ending at A1 in the bus 300, which is optimal in view of power consumption because the hardware components controlled by the write commands are turned on as short a time as possible. In one embodiment, there may be gaps between the pre-requisite operations, but the operations are scheduled as late as possible. As a further scheduling criterion, the most power-hungry operations are scheduled as late as possible such that the total power consumption of the device is minimized.

In one embodiment, if the order of the pre-requisite operations is not decisive, their order is defined by means of minimizing power consumption. Then, the most power-hungry operations are scheduled as late as possible.

The radio protocol in use gives the exact moment of an operation, which may be a start time of a transmission or a reception. The register write or hardware activation operations are set at this time (t_{S}) minus hardware boot-up or settling time. The boot-up or settling time of a device is the time of its slowest component. If the components have greatly different start-up times, the write operations should be performed separately for the slow components and the fast components.

FIG. 4 shows the activation windows 400 and 402 of two parallel dependent devices, which means that all dependent devices have to be operational in order for the whole device to operate. It can be seen that the boot-up time t₁, of the first device is longer than the boot-up time t₂ of the second device. The register write operations of a first device are timed at t_{S}−t₁, and of a second device at t_{S}−t₂, respectively, so that the combination device including the first device and the second device is activated exactly at t_{S}. It may be that the activation of the combination device is a pre-requisite operation to activation of a pre-requisite operation or a critical operation. The sections in the windows to the right from the solid line and depicted with “ACT” illustrate the active periods of the hardware components.

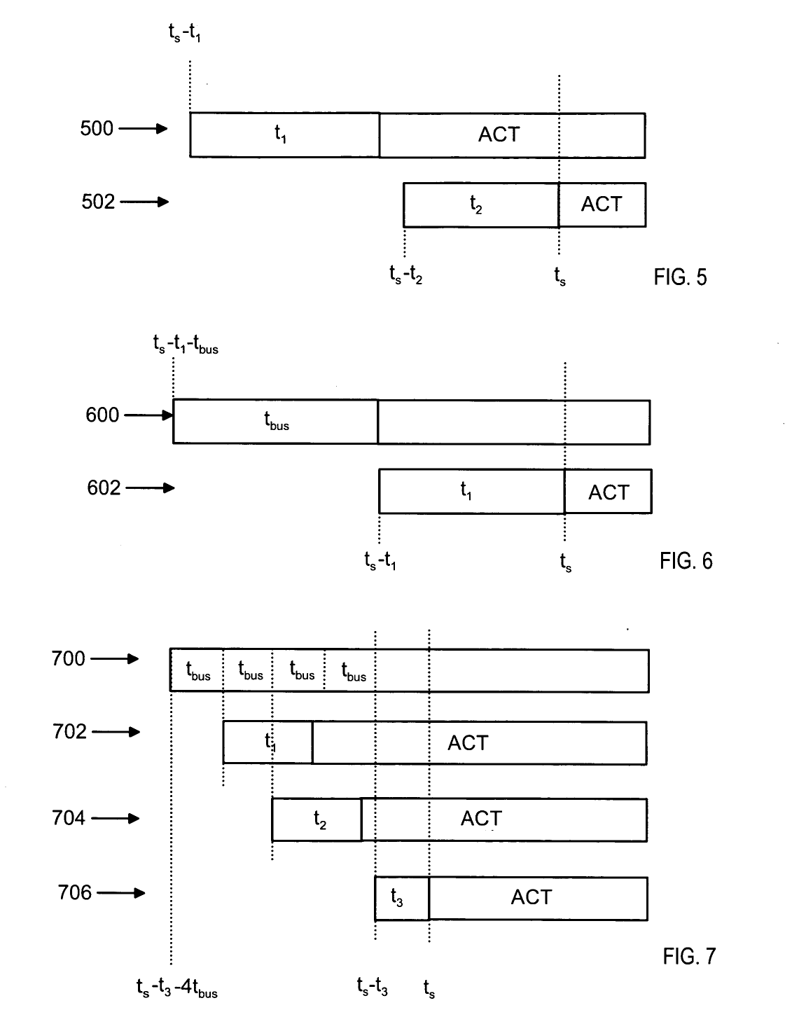

FIG. 5 shows one example of a sequential dependency between components. In sequential dependency, a device shall be active before any dependent devices can be activated. In FIG. 5, a device represented by the window 500 shall be activated before a dependent device represented by the activation window 502 can be activated. The combination device formed by the two devices is activated at the moment t_{S} when the second device has been activated. Referring back to FIG. 3, the critical operation A0 of process A can be considered to be sequentially dependent on the pre-requisite operations A4 to A1.

FIG. 6 illustrates the effect of the bus latency t_{bus} on the scheduling. The bus latency herein denotes the delay caused by the delivery of the write commands in the bus, and executing of the write commands, that is writing the instruction to the hardware register. After the bus latency, the write command is in the register, and it is followed by the hardware boot-up time t₁. At moment tₛ, the hardware is active. The bus latency may thus be taken into account as a sequential dependency when activating hardware. The scheduling command shall be activated early enough such that the bus latency is compensated for.

FIG. 7 shows how multiple write operations can be timed to a bus 700 having a delay t_{bus}. The figure shows how two pre-requisite devices, device 1 having an activation window 702 and device 2 having an activation window 704, are activated before activation of a critical device having an activation window 706. These devices receive their activation order sequentially, that is the first write command in the bus concerns device 1, the second device 2 and the third the critical device. As an example, the critical device of a radio transmitter may be a power amplifier; if it is not operational, no significant RF power is radiated from an antenna of the transmitter. Before the power amplifier is allowed to activate, all other transmitter blocks must also operate properly in order that the transmitter is able to operate according to the standards of the radio network. In the above example, the set of pre-requisite devices would include all transmitter blocks except the synthesizer. As FIG. 7 shows, the pre-requisite devices are activated in order t₁ and t₂, and before activation t₃ of the critical device.

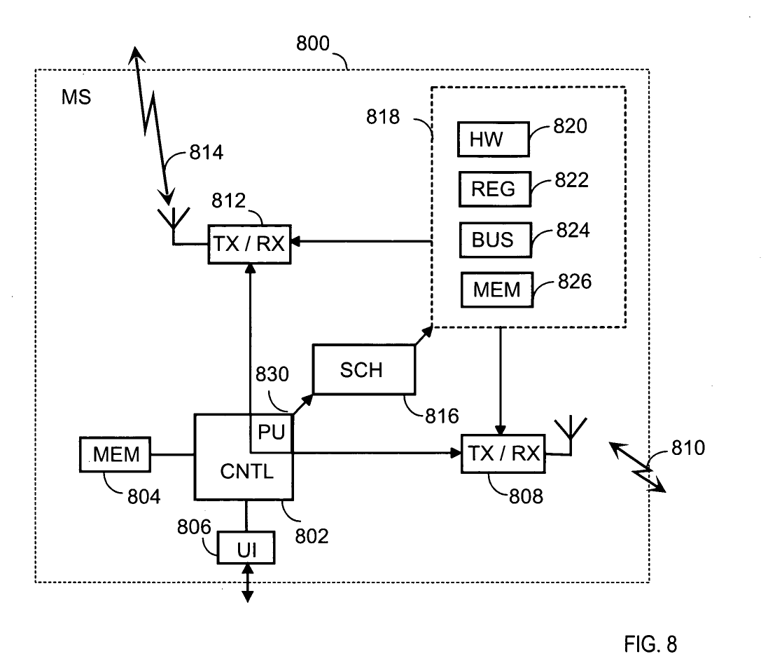

Next, a structure of a communication device 800 providing support for a plurality of different radio protocols will be described with reference to the embodiment of FIG. 8. The communication device may be a mobile phone, a computer, a laptop, or a PDA (Personal Digital Assistant). It should be noticed that the communication device may also provide characteristics of several devices, such as a computer capable of offering wireless data or speech transfer services.

The communication device 800 may comprise a user interface 806 connected to the control unit 802. The user interface 806 may comprise a keyboard, a microphone, a loudspeaker, a display, and/or a camera, for instance.

The communication device 800 of FIG. 8 includes a plurality of communication interfaces 808, 812 to provide respective wireless communication processes 810, 814 to radio network elements, such as base stations. The communication interfaces 808, 812 typically include at least one transceiver. The communication interfaces 812 to 816 usually provide connections employing different radio access technologies.

The communication device 802 further includes a control unit 802 to control functions and provide services to other entities of the device 800. The control unit may provide software and hardware implementations for controlling two-way radio connections between the device 800 and any external radio networks. A memory 804 may be provided for storing software and any other information needed during operation of the device.

The control unit 802 may include a processing unit 830 configured to receive a plurality of operations relating to at least two communication processes, wherein each communication process includes a critical operation and one or more pre-requisite operations, and wherein a scheduling window defining a time window within which an operation is to be scheduled, is defined for each operation.

The multiradio device 800 also includes a scheduler 816. The scheduler may be configured to process any of the method steps disclosed with reference to other embodiments. The control unit may grant different radio protocols an access to hardware, and configure the hardware properly for the active radio protocol. It may also dynamically optimize parallel hardware chains to different systems based on the grants and system prioritization.

The device 800 may also include a hardware module 818. The module may include a pool 820 of hardware components available to different communication processes 810, 814 and the associated device units, such as transceivers 808 and 812, for instance. A shared hardware component may be include a frequency synthesiser, a power amplifier, a radio receiver, a radio transmitter or a crystal oscillator, for instance.

The module may also include a hardware register 822 for storing hardware write commands. A shared medium 824, such as a control bus for transferring hardware write commands, and shared by the multiple communication processes, may also be provided.

A memory 826 for storing configuration information relating to hardware components may also be provided. The hardware components are controlled by writing into their control registers. What is written into the registers depends upon the nature of the desired operation. Typically, the register values are not constant, and they need to be calculated in advance. It may be impossible to carry out the calculations just before the register values are written. Therefore, the values may be calculated and stored in memory in advance and “early enough” before the write operation. The stored value is then placed into the bus and subsequently written into the register at the right moment.

The operation of the device 800 may be such that the processing unit 830 identifies critical and pre-requisite operations relating to communication processes 808, 814, and provides these operations to the scheduler 816. The scheduler may calculate configuration information and put the calculated configuration information in memory 826. At the right moment, the scheduler reads the configuration information from the memory and provides a write command to the bus 824 for activating the associated hardware component. The write command is placed in the hardware register 822 of the hardware component, which activates the hardware component for use by a communication process.

Some of the embodiments performed mainly by the scheduler are provided in the following.

In one embodiment, the scheduler is configured to schedule the operations such that the pre-requisite operations of a communication process precede the critical operations of that communication process, and each pre-requisite operation is scheduled to its scheduling window. The scheduler may determine the scheduling window for each operation. One criterion for determining the scheduling windows is the minimizing of the power consumption of the device.

In one embodiment, the scheduler is configured to schedule the pre-requisite operations of the at least two communication processes at least partly alternately to the shared medium. The operations may be placed alternately in the bus if that is advantageous in view of some predetermined criterion, such as minimizing of power consumption.

In one embodiment, the scheduler is configured to calculate a number of the pre-requisite operations, and determine the time that shall be reserved from the shared medium such that all pre-requisite operations can be scheduled before critical operations. A simple example of this is that if 10 operations need to be scheduled, the time reserved from the bus is at least 10 times the time a single write command takes from the bus.

In one embodiment, the scheduler is configured to schedule the pre-requisite operations such that no time gaps are formed in the shared medium. Optimally, there are no time gaps in the scheduled bus. This is one indicator that the hardware components are not unnecessary in an active state. As a further measure, the scheduler may be configured to schedule the operations such that the most power-hungry operations occur near the deadline, that is the critical operation. This may be carried out on the condition that the order of the pre-requisite operations may be freely chosen.

The scheduler is configured to schedule the critical operations exactly to a predetermined moment of time. When performing this, the scheduler may have to take a bus delay, and a settling time of the critical operation into account. The scheduler may also have to ensure that all pre-requisite operations have been executed in time, that is they are active at the moment the critical operation is expected to be active.

In one embodiment, the scheduler is configured to schedule a de-activation scheduling sequence following the scheduling of operations of the at least two communication processes. In case of de-activating sequences, term post-requisite operation may be used instead of pre-requisite operation.

In a first embodiment, the de-activation scheduling sequence is opposite to the scheduling of operations. Thus, the first operation to be de-activated is the critical operation and then following the de-activation of the critical operation, one or more post-requisite operations are scheduled. In another embodiment, the de-scheduling sequence of the hardware components differs from an opposite of the scheduling sequence. In practise, de-scheduling of a component may include providing a disable signal to the hardware component, or providing a “power down” command changing a value of a hardware bit, for instance.

In one embodiment, the scheduler is configured to schedule two hardware components having different activating times such that they are activated simultaneously. This is called parallel dependency of the components. Then the combination device is activated at the activation moment of the two components.

In one embodiment, the scheduler is configured to schedule the operation such that the hardware component is activated in time by taking into account a voltage regulator power supply delay, the voltage regulator feeding power to the hardware component being activated. This is one example of a sequential dependency, wherein the hardware component is sequentially dependent on activation of the voltage regulator.

Embodiments of the invention or parts of them may be implemented as a computer program comprising instructions for executing a computer process for implementing the method according to the invention.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Other than a computer program implementation solutions are also possible, such as different hardware implementations (modules), e.g. a circuit built of separate logics components or one or more client-specific integrated circuits (Application-Specific Integrated Circuit, ASIC). A hybrid of these implementations is also feasible.

By the shown embodiments, power-efficient multiradio devices, which share a common control bus used by the multiple supported radio protocols, may be implemented.

Furthermore, late reservation of needed hardware components allows construction of power-efficient devices, since the hardware components need not be reserved for unnecessarily long times.

Even though the invention has been described above with reference to an example according to the accompanying drawings, it is clear that the invention is not restricted thereto but it can be modified in several ways within the scope of the appended claims.

1. An apparatus, comprising:
a processing unit configured to receive a plurality of operations relating to at least two communication processes of different radio communication systems, wherein each communication process includes a critical operation and one or more pre-requisite operations, and wherein a scheduling window defining a time window within which an operation is to be scheduled is defined for each operation;
a shared medium configured to handle operations relating to the at least two communication processes;
a scheduler configured to schedule the operations to the shared medium, the scheduler being configured to schedule the operations such that the pre-requisite operations of a communication process precede the critical operation of that communication process, and each pre-requisite operation is scheduled to a corresponding scheduling window.

2. The apparatus according to claim 1, wherein the scheduler is further configured to schedule at least in part, the pre-requisite operations of the at least two communication processes alternately to the shared medium.

3. The apparatus according to claim 1, wherein the scheduler is further configured to schedule the pre-requisite operations such that a predetermined condition is fulfilled.

4. The apparatus according to claim 1, wherein the scheduler is further configured to schedule the pre-requisite operations such that power consumption of the apparatus is minimized.

5. The apparatus of claim 1, wherein the scheduler is further configured to calculate a number of the pre-requisite operations, and determine a time to be reserved from the shared medium such that all pre-requisite operations can be scheduled before critical operations.

6. The apparatus of claim 1, wherein the scheduler is further configured to schedule the pre-requisite operations such that no time gaps are formed in the shared medium.

7. The apparatus of claim 1, wherein the scheduler is further configured to schedule the critical operations at a predetermined moment of time.

8. The apparatus of claim 1, wherein the scheduler is further configured to schedule a de-activation scheduling sequence following the scheduling of operations of the at least two communication processes, the de-activation scheduling sequence being opposite to the scheduling of operations.

9. The apparatus of claim 1, wherein the apparatus is further configured to perform an operation that includes at least one action to activate a hardware component.

10. The apparatus of claim 9, wherein the scheduler is further configured to schedule the hardware component early enough such that the hardware component is active at a desired moment of time by taking a hardware activating time into account.

11. The apparatus of claim 9, wherein the scheduler is further configured to schedule two hardware components having different activation times such that the hardware components are activated simultaneously.

12. The apparatus of claim 9, wherein the scheduler is further configured to schedule two sequentially dependent hardware components such that one of the two hardware components is dependent of activation of the other hardware component, and is only activated after activation of the other hardware component.

13. The apparatus of claim 9, wherein the shared medium is a bus configured to reserve hardware components for use by the at least two communication processes.

14. The apparatus of claim 9, wherein the scheduler is further configured to schedule the operation such that the hardware component is activated in time by taking bus latency into account.

15. The apparatus of claim 9, wherein the scheduler is further configured to schedule the operation such that the hardware component is activated at a time by taking into account a voltage regulator power supply delay, the voltage regulator being configured to feed power to the hardware component being activated.

16. The apparatus of claim 9, wherein the hardware component comprises a frequency synthesiser of a radio device.

17. The apparatus of claim 1, wherein the apparatus comprises a chipset for a radio device.

18. The apparatus of claim 1, wherein the apparatus comprises a mobile phone.

19. An apparatus, comprising:
means for receiving a plurality of operations relating to at least two communication processes of different radio communication systems, wherein each communication process includes a critical operation and one or more pre-requisite operations, and wherein a scheduling window defining a time window within which an operation is to be scheduled is defined for each operation;
means for handling operations relating to the at least two communication processes; and
means for scheduling the operations to the shared medium, the scheduler being configured to schedule the operations such that the pre-requisite operations of a communication process precede the critical operation of that communication process, and each pre-requisite operation is scheduled to its scheduling window.

20. A method, comprising:
receiving a plurality of operations relating to at least two communication processes of different radio communication systems, wherein each communication process includes a critical operation and one or more pre-requisite operations, and wherein a scheduling window defining a time window within which an operation is to be scheduled is defined for each operation; and
scheduling the operations relating to the at least two communication processes to a medium shared by the at least two communication processes such that the pre-requisite operations of a communication process precede the critical operation of that communication process, and each pre-requisite operation is scheduled to its scheduling window.

21. The method of claim 20, further comprising scheduling the pre-requisite operations of the at least two communication processes are at least in part alternately to the shared medium.

22. The method of claim 20, further comprising scheduling the pre-requisite operations such that power consumption of the apparatus is minimized.

23. The method of claim 20, further comprising:
calculating a number of the pre-requisite operations, and
determining a time to be reserved from the shared medium such that all pre-requisite operations can be scheduled before critical operations.

24. The method of claim 20, further comprising scheduling the pre-requisite operations such that no time gaps are formed in the shared medium.

25. A computer program embodied on a computer-readable medium comprising computer code for executing a computer process for implementing the method of claim 20.
